(19) United States
(12) Patent Application Publication
(10) Pub. No.: US 2023/0086378 A1
(43) Pub. Date: Mar. 23, 2023

(54) SHAPED CONVOLUTION KERNELS

(71) Applicant: QUALCOMM Incorporated, San Diego, CA (US)

(72) Inventors: Jamie Menjay LIN, San Diego, CA (US); Yash Sanjay BHALGAT, San Diego, CA (US); Fatih Murat PORIKLI, San Diego, CA (US)

(21) Appl. No.: 17/482,176

(22) Filed: Sep. 22, 2021

(51) Int. Cl. G06N 3/08; G06N 20/10

(52) U.S. Cl. CPC G06N 3/08; G06N 20/10

(57) ABSTRACT

Certain aspects of the present disclosure provide techniques for using shaped convolution kernels, comprising: receiving an input data patch, and processing the input data patch with a shaped kernel to generate convolution output.

### INTRODUCTION

Aspects of the present disclosure relate to convolution, and in particular to use of shaped convolution kernels to improve machine learning.

Convolution has emerged as a useful machine learning technique for processing a wide variety of data. For example, convolutional models may be used to extract features from image data and to identify objects in the underlying images.

Generally, convolution involves applying one or more convolution kernels, each associated with a set of weights, to input data. Applying the convolution kernel involves performing an element-wise multiplication between each element in the convolution kernel and a set of elements in the input data. The kernel is typically applied many times, using a different set of elements from the input data for each application.

Existing convolution models generally use “square” kernels with K×K elements. Typically, K is an odd number to provide symmetry around a kernel center, such as K=3 or K=5. Generally, larger kernel sizes (or extents) correlate to a larger receptive field, which can improve the accuracy of the model. However, larger kernels also require significantly more operations to be performed, which corresponds to significant additional computational resources and processing time. For example, K² multiplications and accumulations may generally be necessary for each application of a K×K kernel. The performance for both training and inferencing with models using convolutional kernels are often constrained by the large number of operations (e.g., floating point operations) required for convolution, which affect processing time, processing power, memory size and utilization requirements, and other processing performance metrics.

Accordingly, what is needed are more efficient convolution techniques that maintain overall model accuracy.

### BRIEF SUMMARY

Certain embodiments provide a computer implemented method to use shaped kernels to improve convolution efficiency, comprising: receiving an input data patch; and processing the input data patch with a shaped kernel to generate convolution output.

Certain embodiments provide a method to train shaped kernels to improve convolution efficiency, comprising: receiving an input data patch associated with a target label; generating an output based in part on processing the input data patch using a shaped kernel; computing a loss based on the generated output and the target label; and refining one or more weight elements of the shaped kernel based on the loss.

Further embodiments relate to apparatuses configured to perform the methods described herein as well as non-transitory computer-readable mediums comprising computer-executable instructions that, when executed by a processor of a device, cause the device to perform the methods described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts processing of input data using convolution kernels, according to some embodiments disclosed herein.

FIG. 2 depicts cruciform convolution kernels and efficient storage of cruciform kernel parameters, according to some embodiments disclosed herein.

FIG. 3 depicts a process for efficient reading, writing, and processing data for shaped kernels.

FIG. 4 depicts various shaped kernels to convolve input data, according to some embodiments disclosed herein.

FIG. 5 is a flow diagram illustrating a method for learning weights of a shaped kernel to accelerate machine learning, according to some embodiments disclosed herein.

FIG. 6 is a flow diagram illustrating a method for using a shaped kernel to accelerate machine learning, according to some embodiments disclosed herein.

FIG. 7 is a flow diagram illustrating a method for using a shaped kernel to improve machine learning, according to some embodiments disclosed herein.

FIG. 8 is a flow diagram illustrating a method for training a shaped kernel to improve machine learning, according to some embodiments disclosed herein.

FIG. 9 is a block diagram illustrating a processing system configured to train and use shaped kernels for improved machine learning, according to some embodiments disclosed herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for using shaped convolution kernels to improve the training and inferencing performance of machine learning models.

Conventional convolution approaches generally utilize square kernels to perform convolution. Although such square convolution kernels are straightforward in definition and operation, they are often not the most efficient form for practical convolution operations given the computational cost of convolution. This is particularly true for many use cases where information redundancy exists spatially or temporally in the activations. That is, using every element in a square kernel may not produce more useful output data compared to a shaped kernel because the information was already captured by other elements of the shaped kernel. In many convolutional neural network architectures and deep learning use cases, using such rectangular kernels results in computational inefficiencies, such as additional compute time and resources for training and inferencing.

Embodiments of the present disclosure use shaped kernels that improve the efficiency of convolution operations, both in the context of convolutional model training and in the context of inferencing with convolutional models.

As used herein, shaped kernels are generally convolution kernels that exclude weights for one or more elements of an input data patch to be processed by the kernel. That is, rather than simply using a “zero” value as the weight for a given element of the kernel or input data patch, the shaped kernel lacks the element entirely, which prevents any multiplication and/or accumulation from being performed on the corresponding element of the input data patch (as would be the case with a zero-valued element). In some aspects, the input data patch therefore lacks the element entirely, as well. This can significantly reduce the number of operations required to apply the kernel to input data, which in turn improves the processing efficiency of training the kernel and inferencing with the kernel (e.g., in terms of memory use, compute time, compute power, compute operations, etc.).

In some embodiments, “cruciform” kernels are used to improve convolution efficiency. As used herein, a cruciform kernel is generally a cross-shaped kernel that includes a center element and four branches off the center element, where each branch includes one or more adjacent branch elements. As will be discussed in more detail below, a cruciform kernel generally does not include corner elements. In some other aspects, the cruciform kernel may include a center element and each corner element, lacking the directly adjacent elements (e.g., in the shape of an “X”).

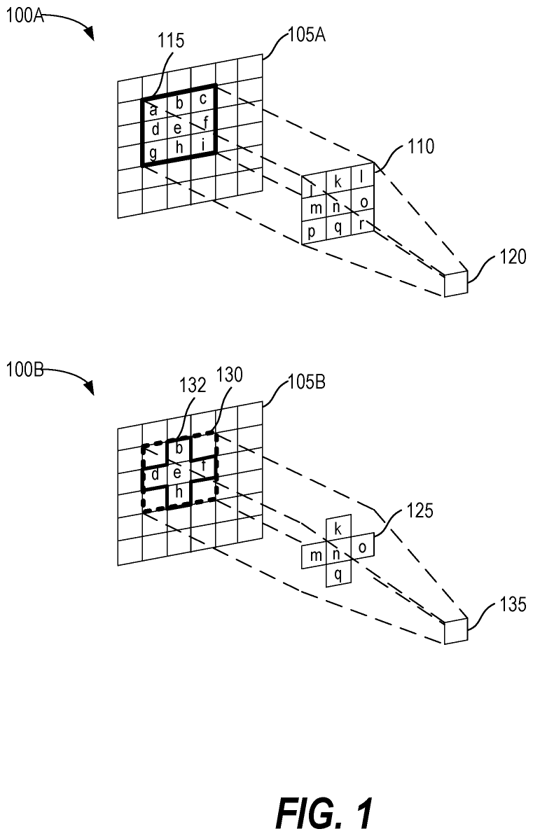

As an example, a traditional 3×3 kernel (e.g., K=3 for a square kernel) includes 9 elements and requires 9 multiplications with corresponding input elements in an input data patch, as well as 8 accumulations of the element-wise multiplications. In contrast, a cruciform kernel having an extent of K⁺=3 includes only five elements (the center, top, right, bottom, and left elements, as depicted in FIG. 1, 100B) and therefore requires only 5 multiplications and 4 accumulations—4 fewer for each operation, or generally a ratio of

$$\frac{2 {K}^{2} - 1}{2 {K}^{+} - 2}$$

in this example. Similarly, a traditional 5×5 kernel (e.g., K=5 for a square kernel) includes 25 elements, while a cruciform kernel having an extent of K⁺=5 includes only 9 elements. Thus, in this example, a cruciform kernel with extent K⁺=5 requires the same number of operations as a conventional 3×3 kernel. Thus, shaped kernels such as cruciform kernels effectively use larger receptive fields without incurring the computational burden of conventional kernels with the same extent.

Although cruciform kernels are discussed herein as examples of shaped kernels, shaped kernels may take many different shapes.

### Example Kernels for Convolutional Neural Networks

FIG. 1 depicts processing of input data using convolution kernels, according to various embodiments described herein.

In particular, operation 100A depicts application of a conventional rectangular kernel (e.g., a square kernel) of size or extent K=3 having K²=9 elements j-r. Operation 100B depicts application of a shaped kernel (in particular, a cruciform kernel) with extent K⁺=3.

In some embodiments, a processing system may use rectangular convolution kernels (depicted by the operation 100A) for one or more layers of a convolutional neural network, while using shaped kernels (depicted by the operation 100B) for one or more other layers. For example, in at least one embodiment, one or more rectangular or square kernels are used in the first (input) layer of the model in order to generate an initial feature map for an input tensor. Subsequently, for one or more internal layers, shaped kernels may be used to convolve the feature map(s) in order to generate an ultimate output.

As illustrated, the operation 100A begins with some input data 105A. Generally, the input data 105A is a tensor of values. In some embodiments, the input data 105A is structured as a matrix. Although a two-dimensional tensor is depicted, in other embodiments, the input data 105A may be one-dimensional, or may include three or more dimensions. For conceptual clarity in the illustrated embodiment, the input data 105A is delineated into squares, where each square corresponds to an element in the input data 105A. Although values are depicted for only a subset of the elements, the input data 105A generally includes a value for each element in the input data 105A.

In some embodiments, the input data 105A may be or represent an image. In one such embodiment, each element in the input data 105A is a pixel in the image. The value of each such element may be, for example, a value indicating the color, brightness, opacity, or other parameter of the pixel. In some embodiments, the input data 105A may be three-dimensional, where each layer or channel of the input data 105A corresponds to a different parameter of each pixel (e.g., a red channel, a blue channel, a green channel, an opacity channel, and so on).

In the illustrated operation 100A, a square convolution kernel 110 of size or extent 3×3 is being applied to an input data patch 115 of size 3×3 having elements a-i. The convolution kernel 110 generally includes a set of elements, where each element corresponds to a weight or value used to process, for example, input data patch 115. For conceptual clarity in the illustrated embodiment, the elements of the convolution kernel 110 are also delineated into squares j-r.

As illustrated, convolution kernel 110 may be applied to input data patch 115, which is defined at least in part on the receptive field of the convolution kernel 110. Generally, the receptive field is defined by the size or extent of the kernel and, therefore, the number of elements in the input data patch 115. That is, during a present convolution operation, the convolution kernel 110 only considers elements within input data patch 115.

In the illustrated operation 100A, applying the convolution kernel 110 to the input data patch 115 results in an output 120. Generally, the convolution kernel 110 may then be moved or “strided” to process a new set of elements of input data 105A, and a new output can be generated.

For example, in the illustrated embodiment, the convolution kernel 110 is centered over the element labeled “e” in the input data 105A. After sliding the kernel to the right by one (e.g., stride=1), the convolution kernel 110 is centered over the “f” element. In some embodiments, outputs 120 are generated sequentially as the convolution kernel 110 is moved across the input data 105A, and the outputs are aligned as a new tensor (sometimes referred to as a feature map or preactivation). This output feature map may be used as input to, for example, a nonlinear operation, such as a ReLU or similar activation function, or to another convolution, or to some other processes (e.g., to a fully connected layer of a neural network that classifies the feature map).

As above, generating the output 120 includes performing element-wise multiplication for the elements in the convolution kernel 110 (a-i) and the set of elements included in the input data patch 115 (j-r). That is, the system may multiply each value specified in the convolution kernel 110 by a corresponding value in the input data patch 115. The resulting values can then be accumulated (e.g., summed) and used as the output 120. In embodiments, this may be referred to as convolving the input data patch 115 with the convolution kernel 110.

In the illustrated embodiment, therefore, the 120 may be defined as: (a*j)+(b*k)+(c*l)+(d*m)+(e*n)+(f*o)+(g*p)+(h*q)+(i*r). Thus, applying the square convolution kernel 110 of extent K=3 requires nine separate multiplications, and eight summations to generate the output 120.

Operation 100B depicts convolution with a shaped kernel 125. In particular, the operation 100B begins with some input data patch 130 of input data 105B. In the illustrated example, the input data patch 130 reflects the effective receptive field of the shaped kernel 125 according to some aspects of the present disclosure. As discussed in more detail below, the shaped kernel 125 may operate on only a subset (e.g., indicated by the cruciform 132) of this data patch 130.

As above with input data 105A, the input data 105B may be a tensor of values of various dimensions. For example, input data 105B may contain image data, audio data, sensor data, or other types of data for convolution.

In the illustrated operation 100B, a shaped convolution kernel 125 is used to process data in input data patch 130. Similarly to the rectangular convolution kernel 110, the shaped convolution kernel 125 generally includes a set of elements (sometimes referred to as weights), where each element specifies a weight or value used to process the input data patch 130. For conceptual clarity in the illustrated embodiment, the elements of the convolution kernel 125 are also delineated into squares.

In the illustrated embodiment, the shaped kernel 125 is a cruciform kernel of extent K⁺=3 (e.g., here the shaped kernel is 3 elements tall (k, n, q) and 3 elements wide (m, n, o)). As illustrated, the cruciform kernel 125 includes a center element (n), as well as a set of four adjacent elements (k, o, q, m) associated with four respective branches of the cruciform. Cruciform kernel 125 does not include any elements for its corners (e.g., corners of a 3×3 square kernel). Specifically, the corner elements labeled “j,” “1,” “p,” and “r” in the square kernel 110 are not included in the shaped kernel 125. In this way, when applying the shaped kernel 125, the system can skip over processing the corresponding corner elements in the input data patch 130 (labeled “a,” “c,” “g”, an “i” in the input data patch 115). That is, rather than use a value of zero to ensure that the corner elements receive no weight, the system refrains from processing them entirely.

As illustrated, the convolution kernel 125 is currently being applied to a subset of the input data 105B, input data patch 130, which represents the receptive field of the shaped convolution kernel 125. That is, when generating output, the convolution kernel 125 only considers a subset of the elements within input data patch 130.

In some embodiments, the input data patch 130 is a square, similar to the input data patch 115 used in operation 100A. However, in the illustrated embodiment, only a subsection of this input data patch 130 is actually processed (indicated by the cruciform 132 in the patch). That is, although the input data patch 130 may include the corner elements, these corner elements may be ignored when performing the convolution. In another embodiment, the input data patch itself may have the same shape as the shaped convolution kernel 125 (e.g., the system may refrain from selecting the corner elements entirely).

In the illustrated operation 100B, applying the convolution kernel 125 to the input data patch 130 results in an output 135. As above, the convolution kernel 125 may then be moved or strided across input data 105B to generate additional output, such as may be used to form a multi-element output feature map, which can then be used in further model processing.

In contrast to the example process of 100A, the output 135 of example operation 100B may be defined generated with fewer mathematical operations according to (b*k)+(d*m)+(e*n)+(f*o)+(h*q). Thus, applying the cruciform convolution kernel 125 of extent three requires significantly fewer operations. Notably, experimentation has revealed the unexpected result that the shaped kernel performs as well or better than the conventional square kernel, despite the reduction in convolution elements considered by operation 100B.

This may be because of the distance from each element in the input data patch center of the patch. Each element directly adjacent to the center element (elements b, d, f, and h) has a distance of 1 to the center element (e). However, corner elements (labeled a, c, g, and i) have a distance equal to \sqrt{2}. This increased distance corresponds to a decreased significance to the center element, as compared to the directly adjacent elements. Thus, in an embodiment, they can be ignored with little or no reduction in the quality or accuracy of the model. Indeed, experimentation has shown that convolution models using a cruciform kernel such as shaped kernel 125 can achieve very similar (and in some instances, better) accuracy than the traditional kernel 110 of the same extent. Additionally, because of the reduced number of operations and weights, the shaped kernel 125 can be used more efficiently and the models require reduced computational resources.

Further, as discussed above, increasing the receptive field of the kernel (by increasing its size or extent) can improve model accuracy (at the cost of increased computing requirements and/or latency). However, by using a cruciform or other shaped kernel 125, the receptive field can be increased with a smaller effect on the number of operations and model weights, as compared to traditional kernels 110. For example, a cruciform kernel of extent K⁺=5 requires nine multiplications per application (the same as a standard kernel of extent K⁺=3), while a standard kernel extent K=5 requires twenty-five. Experimentation has demonstrated that models using such (larger) shaped kernels can provide increased accuracy with similar computational complexity of (smaller) traditional kernels.

### Example Cruciform Kernels and Efficient Storage of Shaped Kernels

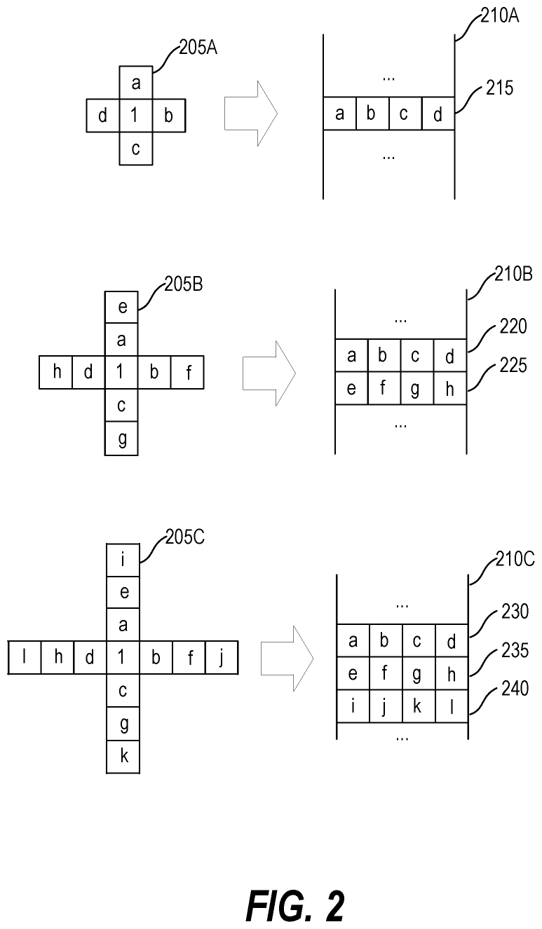

FIG. 2 depicts efficient methods for storing shaped kernel data in a memory.

Memory and storage systems are typically organized into multiples of 2ⁿ bits (e.g., 4 bits, 8 bits, 16 bits, and so on) referred to as “pages,” “blocks,” or “words.” That is, data is typically stored in fixed-sized blocks of some multiple of 2ⁿ bits. Traditional kernels, however, specify a number of weights that does not align with this 2ⁿ value. For example, square kernels of extent K=3 include nine weights. Such traditional kernels cannot be packed efficiently into ordinary storage systems, because they overlap into a new block that will be left largely empty. For example, suppose each weight is eight bits, and each block is thirty-two bits long. Each block can therefore store exactly four weights. If the square kernel requires nine weights, then it will require three blocks (two completely filled blocks to store eight of the weights, and one block that is one-quarter full for the ninth weight). This results in wasted space in the storage or memory.

Cruciform kernels, though they require reduced storage space, may have similar concerns. For example, a cruciform kernel of extent K⁺=3 may specify five weights, requiring two blocks of storage or memory space (one of which is largely empty). In some embodiments, therefore, partially-fixed cruciform kernels are introduced. In the illustrated embodiment, the cruciform kernels 205 are partially-fixed cruciform kernels. As used herein, a partially-fixed cruciform kernel has a predefined fixed weight in the center element, whereas branch elements have learnable weights.

In some embodiments, the fixed center weight of a partially-fixed cruciform kernel 205 has a value of zero or one. If the value of the center element is zero (indicating that the corresponding element of the input data has no effect on the output of the convolution), then the element can be ignored when convolving input data. That is, the system need not store any weight for the center element, nor do any operations (e.g., multiplications or summations) need to be performed based on the center element.

If the value of the center element is one, in some embodiments, the system can use a skip connection to bring the corresponding element in the input data straight to the summation operation. That is, the system need not store a weight for the center element, nor does it need to perform multiplication for the center element. Instead, the value of the corresponding element in the input data is simply added to the results of multiplying the other kernel elements.

Advantageously, the number of weights specified by any partially-fixed cruciform kernel 205 is a multiple of four, which can significantly improve the efficiency of storing and using the kernel.

In the illustrated embodiment, a partially-fixed cruciform kernel 205A of extent K⁺=3 includes a fixed center value of 1, as well as branch values of “a,” “b,” “c,” and “d.” That is, the partially-fixed cruciform kernel 205A specifies four weights (“a,” “b,” “c,” and “d.”). Specifically, the cruciform kernel 205A has a weight of “a” for the top element, a weight of “b” for the right element, a weight of “c” for the bottom element, and a weight of “d” for the left element.

As illustrated, these weights can be efficiently packed in a memory 210A. This memory 210A may include, for example, a cache, a random access memory (RAM), a tightly coupled-memory (TCM), and the like. In the illustrated embodiment, the storage 210A is delineated into “words”, which represent one row of memory values, and the weights of the cruciform kernel 205A are stored in a single word 215. For example, if the word is 32 bits (four bytes) and each weight is 8 bits (one byte), the weights of the cruciform kernel 205A can be efficiently packed in a single word 215 in storage 210A. Thus, for systems that use 32-bit words, the cruciform kernel 205A can be stored without wasting any portions of the storage 210A.

Additionally, in some embodiments, this efficient storage enables the system to use predefined offsets when selecting the weights. For example, the system may maintain a pointer to the first weight (“a”), and use a predefined offset (e.g., 8 bits) to retrieve each subsequent weight.

FIG. 2 also depicts a partially-fixed cruciform kernel 205B of extent K⁺=5. As illustrated, the cruciform kernel 205B includes two elements on each branch of the kernel, as well as a center element. The top branch includes elements labeled “a” and “e,” the right branch includes elements labeled “b” and “f,” the bottom branch includes elements labeled “c” and “g,” and the left branch includes elements labeled “d” and “h.” These eight weights can similarly be efficiently stored in storage 210B using two words 220 and 225, and the same efficient predefined pointer offset method can be used for referencing weight locations in memory.

FIG. 2 also depicts a partially-fixed cruciform kernel 205C of extent K⁺=7. As illustrated, the cruciform kernel 205C includes three elements on each branch of the kernel, as well as a center element. The top branch includes elements labeled “a,” “e,” and “i,” the right branch includes elements labeled “b,” “f,” and “j,” the bottom branch includes elements labeled “c,” “g,” and “k,” and the left branch includes elements labeled “d,” “h,” and “1.”

As with the previous examples, these twelve weights can also be efficiently stored in storage 210C using three words 230, 235, and 240 and can be referenced efficiently in the memory using predefined offsets, as discussed above. For example, the system may maintain a pointer to the first weight (“a”), and use a predefined offset (e.g., 8 bits) to retrieve each subsequent weight.

Notably, cruciform kernels 205A-C in FIG. 2 are just some examples, and cruciform kernels may generally use any number of elements on each branch. In some embodiments, the cruciform kernels 205 may be asymmetric or “irregular” (e.g., with more elements on one or more branches, as compared to one or more other branches). Generally, expanding the extent of a regular cruciform kernel by one means adding four elements to the kernel: one to the end of each branch (moving away from the center). In some embodiments, non-cruciform shaped kernels can be created by selectively adding elements in other locations, as discussed in more detail below.

Generally, using shaped kernels (such as cruciform kernels and partially-fixed cruciform kernels) can significantly reduce the computational complexity of machine learning models. For example, using a traditional square kernel of extent K=3 and a stride of 1 to process input data requires a number of multiplications equal to cₒᵤₜ cᵢₙ H*W*9, where cₒᵤₜ and cᵢₙ correspond to the number of channels in the output and input, respectively, and H and W correspond to the height and width of the input, respectively. The number of weights that must be maintained for a square kernel of extent K=3 is equal to cₒᵤₜ*cᵢₙ*9.

In contrast, using a cruciform shaped kernel of extent K⁺=3 and a stride of 1 to process input data requires a number of multiplications equal to cₒᵤₜ*cᵢₙ*H*W*5 (or cₒᵤₜ*cᵢₙ*H*W*4 if the cruciform is partially-fixed). The number of weights that must be maintained for a cruciform kernel of extent K⁺=3 is equal to cₒᵤₜ*cᵢₙ*5 (cₒᵤₜ*cᵢₙ*4 if the cruciform is partially-fixed).

### Example Process for Reading, Writing, and Processing Data for Shaped Kernels

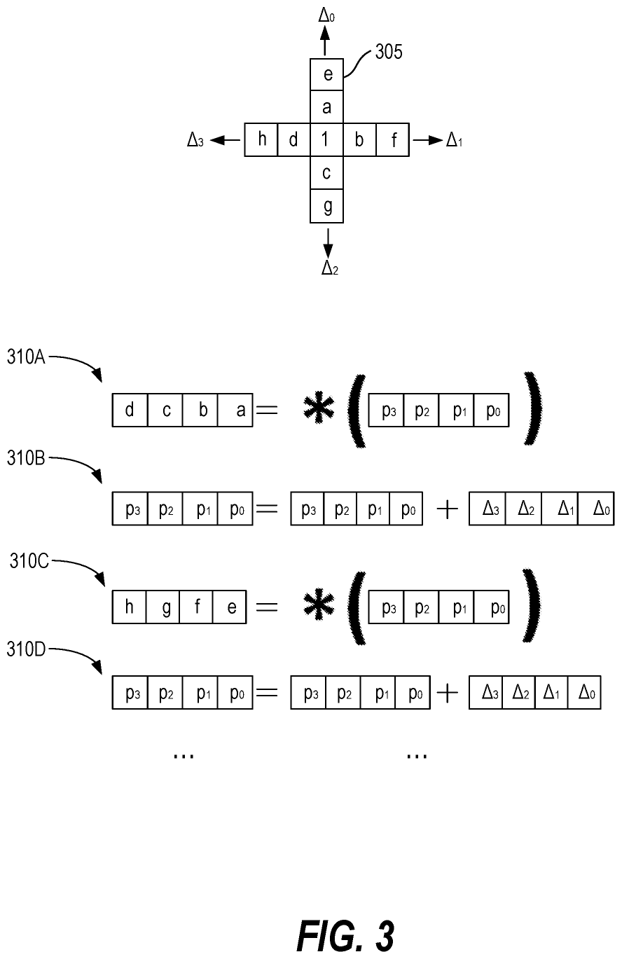

FIG. 3 depicts a process for efficient reading, writing, and processing data for shaped kernels.

In the illustrated embodiment, a partially-fixed cruciform shaped kernel 305 specifies a fixed value for the center element, with learnable values for the branch elements. In some embodiments, as discussed above, the learnable weights can be packed efficiently for storage such that fixed offsets can be used to move pointers between them. In embodiments, the activations for each element can similarly be packed efficiently in memory. In the illustrated example, each branch is associated with a respective fixed offset Δₙ. That is, each branch may have an offset with a different magnitude. In some embodiments, each branch can use a fixed offset of the same magnitude.

The offset indicates how to locate a given weight on the branch (or an activation for a given element), given a pointer to a first weight (or activation). For example, given a pointer to the “b” weight, one should add an offset equal to Δ₁ to find the “f” weight. Given a pointer to the activation of the “b” element, one can add an offset equal to Δ₁ to retrieve the activation for the “f” element. If the shaped kernel 305 is larger with another element beyond “f,” one could add 2*Δₙ to the pointer to the “b” weight or activation in order to retrieve the next weight or activation beyond “f.”

This enables fast and efficient reading and writing of the kernel weights and activations. Specifically, suppose pointers p₃, p₂, p₁, and p₀ currently point to the addresses of weights (or activations) for d, c, b, and a, respectively. As illustrated by operation 310A, the first four weights or activations (d, c, b, a) can be retrieved by dereferencing these pointers p₃, p₂, p₁, and p₀. Subsequently, as illustrated by operation 310B, the pointers p₃, p₂, p₁, and p₀ are each incremented by the respective offset Δ₃, Δ₂, Δ₁, and Δ₀ that corresponds to the branch with which the pointer is associated.

As indicated by operation 310C, the next set of four weights or activations (h, g, f, e) can then be retrieved by dereferencing these updated pointers p₃, p₂, p₁, and p₀. If additional weights or activations remain (e.g., the kernel 305 is of extent K⁺=5 or more), as illustrated by operation 310D, the pointers p₃, p₂, p₁, and p₀ are again each incremented by their respective offsets Δ₃, Δ₂, Δ₁, and Δ₀. As indicated by the ellipses, this process can be repeated to rapidly retrieve, process and/or store all of the weights specified in the kernel, as well as the activations for the kernel.

Further, in some embodiments, the system may process multiple weights and/or activations synchronously (e.g., in parallel). For example, the system may use single instruction, multiple data (SIMD) operations when modifying or applying the weights and computing activations. In one such embodiment, the system may retrieve the first four weights (“a,” “b,” “c,” and “d”) for processing, as described above. Using SIMD operations, the system can then efficiently modify or otherwise process the retrieved weights in parallel. Subsequently, as discussed above, the system can simply increment the pointer by an offset (e.g., one word), and use this updated pointed to retrieve the next set of weights (“e,” “f,” “g,” and “h”). This can significantly improve the efficiency of retrieving and operating on the weights, as they can be rapidly retrieved with minimal operations (dereferencing a pointer, followed by a fixed increment). The retrieved weights can then be evaluated or operated on in parallel using SIMD operations. This reduces the latency and computational complexity of using the partially-fixed cruciform shaped kernel 305.

### Example Shaped Kernels for Improved Convolutional Neural Networks

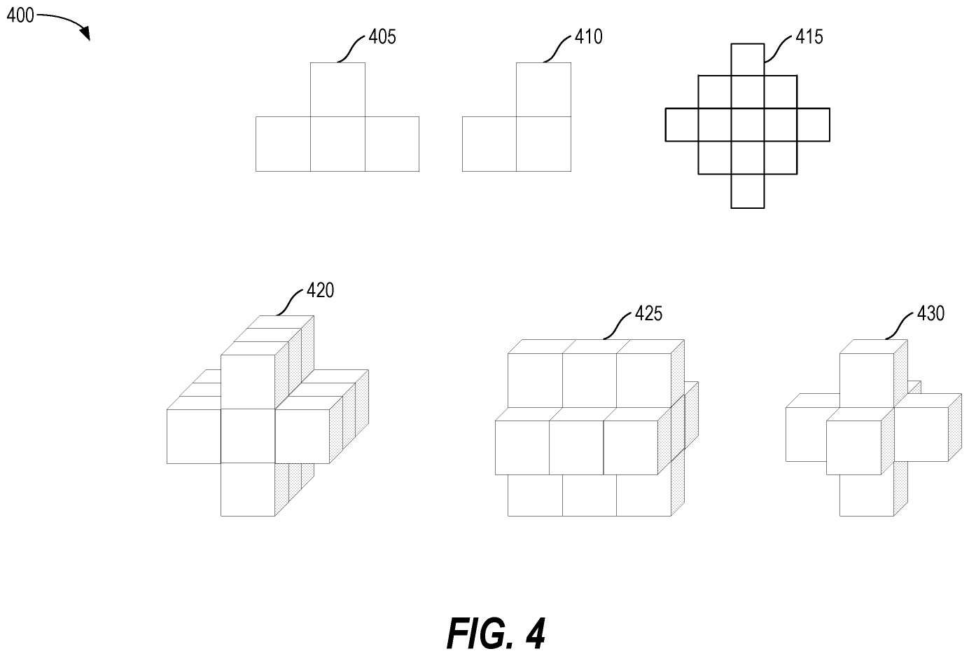

FIG. 4 depicts various shaped kernels to convolve input data, according to embodiments disclosed herein. In the illustrated embodiment, the shaped kernel 405 is similar to a cruciform kernel, but with one branch (the bottom branch) removed. Similarly, the shaped kernel 410 has two branches removed. Such shaped kernels will require fewer computing resources to be applied, and may be useful in particular implementations depending on the characteristics of the input data, the stride settings, etc.

Similarly, the shaped kernel 415 includes a central square with an additional element added at the center of each edge. As discussed above with reference to cruciform kernels, this may allow the shaped kernel 415 to have a larger receptive field (extending an extra element (e.g., pixel in each direction) while only adding only a fraction of the additional operations (multiplications and accumulations) as compared to a square kernel with its dimension extended by 1 unit.

Further, in FIG. 4, the shaped kernels 420, 425, and 430 are three-dimensional shaped kernels. Such kernels may be applied to efficiently extract features from three-dimensional input data, such as multi-channel image, video, or audio data. For example, the three-dimensional kernels may be used to provide convolution spatially (in two dimensions) as well as in depth (e.g., across input channels). In some embodiments, such kernels may be applied to efficiently extract features from three-dimensional input data, such as video (with a series of two-dimensional spatial frames over time) or audio data with two-dimensional spectrograms (using frequency-time/Fourier transform) over time.

### Example Method for Using Shaped Kernels to Accelerate Training of Convolutional Neural Networks

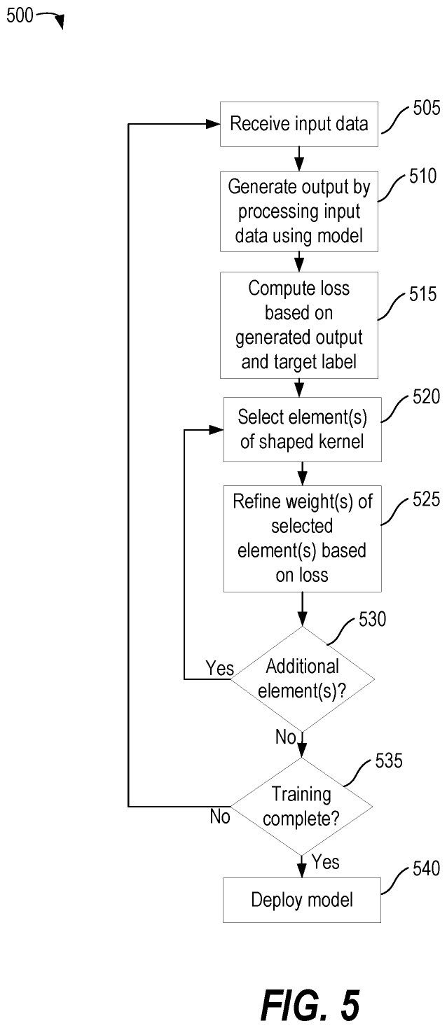

FIG. 5 is a flow diagram illustrating a method 500 for learning weights of a shaped kernel to accelerate machine learning, according to embodiments disclosed herein.

In some embodiments, some or all of the weights of a given kernel are learned during a training process. For example, a convolutional neural network layer may be associated with one or more kernels, and the weights of each kernel can be iteratively refined based on training data. This allows the kernels to adapt and learn to identify relevant features for the desired output. In at least one aspect, the training can occur incrementally or intermittently during inferencing (e.g., by periodically refining or adjusting the weights during an inference stage).

Generally, training the model requires iteratively refining each weight of each kernel. Thus, as the size or extent of the kernels expand, the number of operations required similarly expands. In embodiments, therefore, use of shaped kernels can accelerate the training procedure by eliminating some kernel elements, and thereby reducing the number of operations that must be performed to update the kernel. As noted above, experimentation has shown that the shaped kernels can perform as well or even better than conventional kernels, despite their reduced weighting.

The method 500 begins at block 505, where input data is received by a model training system. For example, this input data may include image data, audio data, sensor data, program data, or any other type of data.

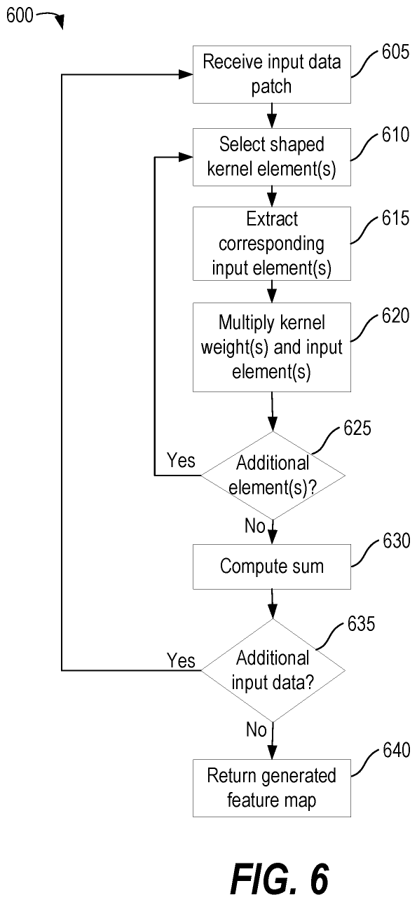

The method 500 then proceeds to block 510, where the training system generates an output by processing the input data using the model. Initially, the resulting output may not be accurate, such as when the training system instantiates the model with random parameters (e.g., weights and biases). However, during training, these parameters are iteratively refined to improve the model output. Generating output using shaped kernels is discussed in more detail below with reference to FIG. 6.

The method 500 then continues to block 515, where the training system computes a loss based on the generated output and a target label for the data. In an embodiment, the target label indicates the desired model output for the input data. For example, if the training system is training a model to classify input images based on the animal(s) depicted in them, the target label may indicate which animal(s) are present in the corresponding input image. Generally, the loss reflects the difference between the actual output and the desired or target output. In some embodiments, this loss can be used to refine one or more model parameters (e.g., weights and biases) in order to improve its accuracy.

In one aspect, the blocks 520 through 530 are performed as part of a back-propagation process for training the network. That is, the loss may be back-propagated through the model (allowing gradients to be generated at each layer), and blocks 520, 525, and 530 may be repeated for each shaped kernel encountered during the back-propagation.

At block 520, the training system selects one or more elements of a shaped kernel used in the model. In some embodiments, the training system can select and process each element sequentially. In another, the training system selects multiple elements for parallel processing (e.g., using SIMD operations). The shaped kernel may be a partially-fixed cruciform kernel, and the training system may first select the elements which are immediately adjacent to the center element (e.g., elements “a,” “b,” “c,” and “d” in FIG. 2).

The method 500 then continues to block 525, where the training system refines the parameters (e.g., weight(s)) associated with the selected element(s) based at least in part on the computed loss. In some embodiments, if the shaped kernel is a partially-fixed cruciform with a fixed weight of one in the center element, the weights of the adjacent elements are refined relative to this fixed center element.

The method 500 then continues to block 530, where the training system determines whether there are any additional elements in the shaped kernel. If so, the method 500 returns to block 520 to select the next set of one or more elements. In at least one embodiment, as discussed above, the training system can select the next set of element(s) by incrementing a memory pointer by a fixed value. For example, referring to FIG. 2, if the pointer currently points to word 220, the training system may increment it by the size of a word, such that it points to word 225.

If the training system determines, at block 530, that no additional elements in the shaped kernel remain to be refined, the method 500 continues to block 535 where the training system determines whether training is complete. This may include, for example, determining whether additional training data is available, determining whether a predefined number of training iterations have been performed, determining whether the model has reached an accuracy threshold, and the like.

If training is not complete, the method 500 returns to block 505. Otherwise, the method 500 continues to block 540, where the model training system makes the trained model available, such as by deploying the trained model to a system. The model, with one or more shaped kernels, can then be used to process input at runtime, in other words, to perform inferencing.

Although the method 500 refers to a single shaped kernel, in embodiments, there could be any number of kernels (shaped and unshaped) in the model. Similarly, although the illustrated method depicts updating the model parameters for each individual sample (e.g., stochastic gradient descent), in some embodiments, the training system may use batch training.

### Example Method for Using Shaped Kernels to Accelerate Processing of Input Data Using Convolutional Neural Networks

FIG. 6 is a flow diagram illustrating a method 600 for using a shaped kernel to accelerate inferencing with a machine learning model, according to embodiments disclosed herein.

The method 600 begins at block 605, where an inference system receives input data patch at runtime. In embodiments, the input data patch is a portion of input data, which may be in the form of a tensor. For example, the inference system may receive an image for processing, where the desired output is a classification of the object(s) in the image. In some embodiments, the input data patch is rectangular or square, regardless of the type or shape of kernel to be applied.

At block 610, the inference system selects one or more elements of a shaped kernel to apply to the input data.

In one embodiment, the inference system can process each element of the shaped kernel individually. In some embodiments, however, the inference system can select multiple kernel elements for synchronous processing (e.g., using SIMD operations, as described above).

At block 615, the inference system identifies and extracts the element(s) from the input data patch that correspond to the selected kernel weight(s). For example, referring to FIG. 1, the corresponding input element for kernel element “n” is input element “e.”

In some embodiments, to identify and extract the relevant input elements, the inference system can identify and extract the center element from the input patch, as well as the corresponding branch element(s). If the kernel is a cruciform kernel, the corner elements in the data patch may be ignored. That is, the input data patch may include m elements while the shaped kernel includes n elements, where n<m. In applying the kernel, therefore, the remaining m-n elements are ignored.

In some other aspects, as discussed above, the received data patch may correspond to only the relevant elements (e.g., the corner elements may not be included). In one such aspect, block 615 may be bypassed.

The method 600 then continues to block 620, where the inference system performs element-wise multiplication by multiplying each weight of the selected kernel elements with the respective corresponding input element value. In some embodiments, as discussed above, the inference system can do so using one or more SIMD multiplication operations.

At block 625, the inference system determines whether the shaped kernel includes additional elements that have not yet been used to process the input data. If so, the method 600 returns to block 610. In some embodiments, as discussed above, the inference system may select the next set of kernel element(s) by incrementing a pointer using a predefined value.

If all of the kernel elements have been used to process the input data, then the method 600 continues to block 630, where the inference system computes the sum by accumulating the element-wise multiplications. In at least one embodiment, if the shaped kernel is a partially-fixed cruciform kernel with a value of one in the center element, then the inference system can additionally add the corresponding input element directly to this sum and bypass any multiplication for the center element. That is, the center element is not multiplied by any kernel weight. The result of this summation is then used as the output value for this application of the shaped kernel.

The method 600 then continues to block 635, where the inference system determines whether there are additional input data patch(es) remaining that need to be processed using the kernel. In some embodiments, as discussed above, a kernel can be repeatedly used to process different subsets of the input data, such as by iteratively striding the kernel across the input data to extract a new data patch. The resulting output values can then be aggregated to form a convolved feature map, which is the net result of convolving the input data patches with the shaped kernel. If additional applications remain, the method 600 returns to block 605. Otherwise, the method 600 continues to block 640.

At block 640, the inference system returns the generated feature map as output. In some embodiments, as discussed above, the shaped kernel is used in an internal layer of the model. In such an embodiment, the feature map may be provided to a subsequent layer in the model.

Although the method 600 refers to a single shaped kernel, in embodiments, there could of course be any number of kernels (shaped and unshaped) in the model.

### Example Method for Inferencing with a Model Having Shaped Kernels

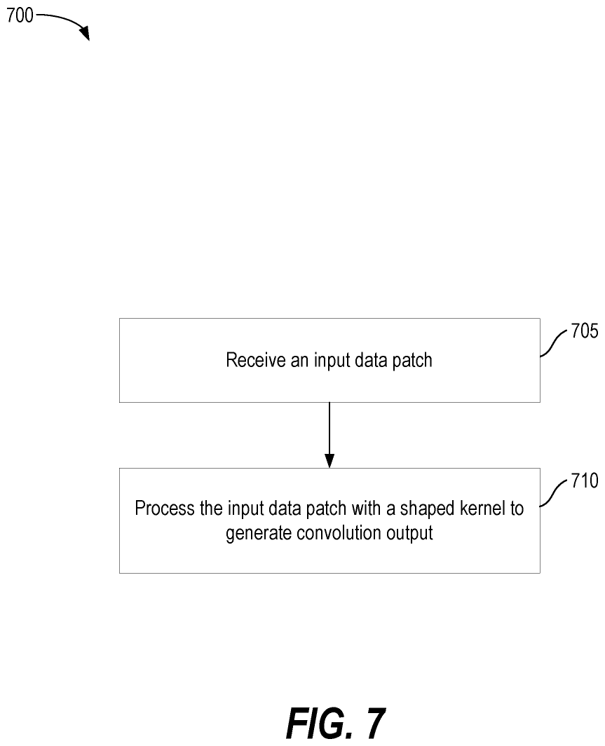

FIG. 7 is a flow diagram illustrating a method 700 for using a shaped kernel to improve machine learning, according to some embodiments disclosed herein.

At block 705, an input data patch is received.

At block 710, the input data patch is processed with a shaped kernel to generate convolution output.

In some embodiments, the shaped kernel is associated with a layer of a convolutional neural network model and the input data patch comprises input data element values generated, at least in part, by a square convolution kernel of a preceding layer of the convolutional neural network model.

In some embodiments, the shaped kernel comprises a cruciform kernel. Additionally, in some embodiments, the shaped kernel comprises a partially-fixed cruciform kernel, wherein a center weight element of the shaped kernel comprises a fixed weight.

In some embodiments, the input data patch comprises a set of m input data elements, the shaped kernel comprises a set of n weight elements, n<m, and processing the input data patch with the shaped kernel comprises processing n input data elements of the input data patch with n corresponding elements of the shaped kernel to generate the convolution output.

In some embodiments, processing n elements of the set of m input data elements of the input data patch with n corresponding elements of the shaped kernel comprises: performing an elementwise multiplication between n−1 input data elements and n−1 weight elements, and processing the center weight element with a skip connection.

In some embodiments, processing the n elements of the set of m input data elements of the input data patch with the n corresponding elements of the shaped kernel comprises using single instruction, multiple data (SIMD) operations to apply multiple weight elements in parallel.

In some embodiments, the method further includes retrieving a first set of weight elements using one or more pointers, incrementing the one or more pointers using one or more fixed offsets, and retrieving a second set of weight elements using the one or more pointers.

### Example Method for Training a Model Including Shaped Kernels

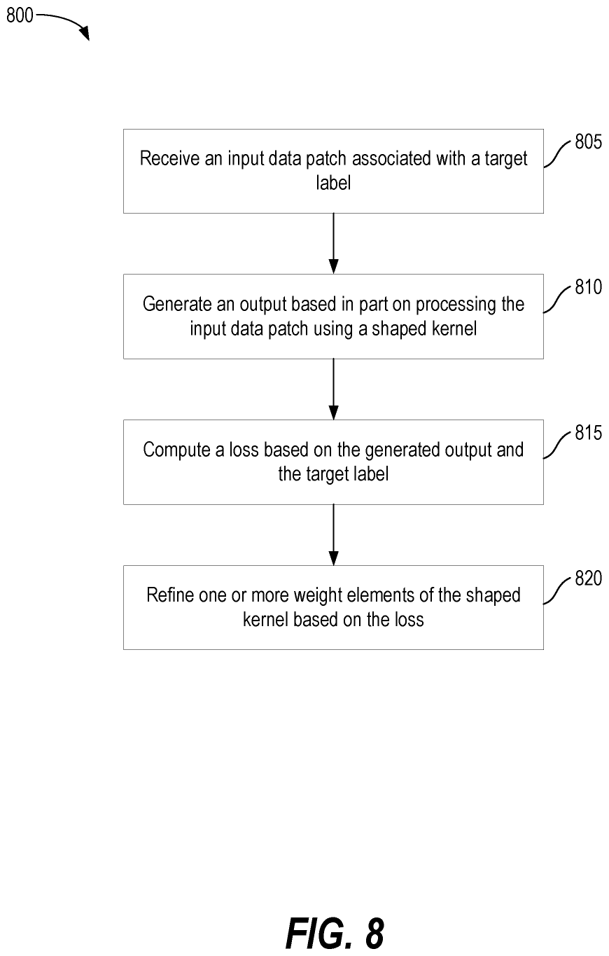

FIG. 8 is a flow diagram illustrating a method 800 for training a shaped kernel to improve machine learning, according to some embodiments disclosed herein.

At block 805, an input data patch associated with a target label is received.

At block 810, output is generated based in part on processing the input data patch using a shaped kernel.

In some embodiments, the shaped kernel is associated with an internal layer of a convolutional neural network model and the input data patch comprises input data element values generated, at least in part, by a square convolution kernel of a preceding layer of the convolutional neural network model.

In some embodiments, the shaped kernel comprises a cruciform kernel. Additionally, in some embodiments, the shaped kernel comprises a partially-fixed cruciform kernel, wherein a center weight element of the n weight elements comprises a fixed weight.

At block 815, where the processing system computes a loss based on the generated output and the target label.

At block 820, the processing system refining one or more weight elements of the shaped kernel based on the loss.

In some embodiments, refining the one or more of weight elements comprises using single instruction, multiple data (SIMD) operations to refine multiple weight elements in parallel.

In some embodiments refining the one or more weight elements comprises retrieving a first set of weight elements using one or more pointers, incrementing the one or more pointers using one or more fixed offsets, and retrieving a second set of weight elements using the one or more pointers.

### Example System for Machine Learning Using Shaped Kernels

In some embodiments, the methods and workflows described with respect to FIGS. 5-8 may be performed on one or more devices. For example, training and inferencing may be performed by a single device or distributed across multiple devices. Often a model will be trained on a powerful computing device and then deployed to many other devices to perform inferencing.

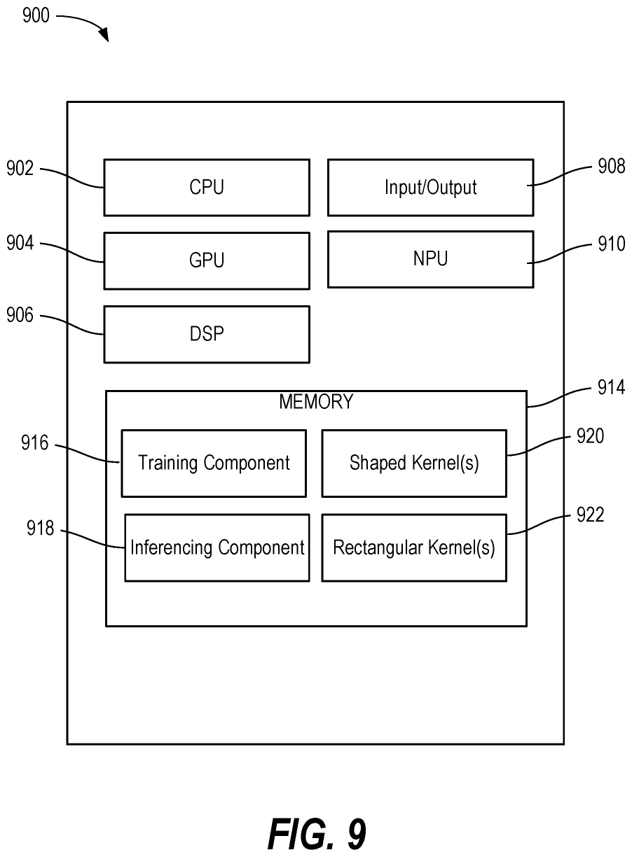

FIG. 9 is a block diagram illustrating a processing system 900 which may be configured to perform aspects of the various methods described herein, including, for example, the methods described with respect to FIGS. 5-8.

Processing system 900 includes a central processing unit (CPU) 902, which in some examples may be a multi-core CPU. Instructions executed at the CPU 902 may be loaded, for example, from a program memory associated with the CPU 902 or may be loaded from a memory 914.

Processing system 900 also includes additional processing components tailored to specific functions, such as a graphics processing unit (GPU) 904, a digital signal processor (DSP) 906, and a neural processing unit (NPU) 910.

Though not depicted in FIG. 9, NPU 910 may be implemented as a part of one or more of CPU 902, GPU 904, and/or DSP 906.

The processing system 900 also includes input/output 908. In some embodiments, the input/output 908 can include one or more network interfaces, allowing the processing system 900 to be coupled to a one or more other devices or systems via a network (such as the Internet).

Although not included in the illustrated embodiment, the processing system 900 may also include one or more additional input and/or output devices 908, such as screens, physical buttons, speakers, microphones, and the like.

Processing system 900 also includes memory 914, which is representative of one or more static and/or dynamic memories, such as a dynamic random access memory, a flash-based static memory, and the like. In this example, memory 914 includes computer-executable components, which may be executed by one or more of the aforementioned processors of processing system 900.

In this example, memory 914 includes a training component 916 and an inferencing component 918. The memory 914 also includes a set of shaper kernels 920 and rectangular kernels 922. The depicted components, and others not depicted, may be configured to perform various aspects of the methods described herein. For example, the training component 916 may be configured to receive and process data and labels to train one or more convolutional neural networks (e.g., by updating the weights of the shaped kernels 920 and rectangular kernels 922), and the inferencing component 918 may utilize the trained models (e.g., the shaped kernels 920 and rectangular kernels 922) to process input data during runtime.

### Example Clauses

Clause 1: A method, comprising: receiving an input data patch comprising a set of m input data elements; determining to use a shaped kernel to process the input data patch, wherein the shaped kernel comprises a set of n weight elements, and wherein n<m; and processing n elements of the set of m input data elements of the input data patch with n corresponding elements of the shaped kernel to generate convolution output.

Clause 2: The method of clause 1, wherein: the shaped kernel is associated with a layer of a convolutional neural network model, and the input data patch comprises input data element values generated, at least in part, by a square convolution kernel of a preceding layer of the convolutional neural network model.

Clause 3: The method of any of Clauses 1-2, wherein the shaped kernel comprises a cruciform kernel.

Clause 4: The method of any of Clauses 1-3, wherein the shaped kernel comprises a partially-fixed cruciform kernel, wherein a center weight element of the n weight elements comprises a fixed weight.

Clause 5: The method of any of clauses 1-4, wherein processing n elements of the set of m input data elements of the input data patch with n corresponding elements of the shaped kernel comprises: performing an elementwise multiplication between n−1 input data elements and n−1 weight elements; and processing the center weight element with a skip connection.

Clause 6: The method of any of clauses 1-5, wherein n is an even multiple of four.

Clause 7: The method of any of clauses 1-6, wherein processing then elements of the set of m input data elements of the input data patch with the n corresponding elements of the shaped kernel comprises using single instruction, multiple data (SIMD) operations to apply multiple weight elements in parallel.

Clause 8: the method of any of clauses 1-7, the method further comprising: retrieving a first set of weight elements using one or more pointers; incrementing the one or more pointers using one or more fixed offsets; and retrieving a second set of weight elements using the one or more pointers.

Clause 9: A method, comprising receiving an input data patch comprising a set of m input data elements, wherein the input data patch is associated with a target label; determining to train a shaped kernel based on the input data patch, wherein the shaped kernel comprises a set of n weight elements, and wherein n<m; generating an output based in part on processing the n elements of the set of m input data elements using the shaped kernel; computing a loss based on the generated output and the target label; and refining one or more of the set of n weight elements based on the loss.

Clause 10: The method of clause 9, wherein: the shaped kernel is associated with an internal layer of a convolutional neural network model, and the input data patch comprises input data element values generated, at least in part, by a square convolution kernel of a preceding layer of the convolutional neural network model.

Clause 11: The method of any of clauses 9-10, wherein the shaped kernel comprises a cruciform kernel.

Clause 12: The method of any of clauses 9-11, wherein the shaped kernel comprises a partially-fixed cruciform kernel, wherein a center weight element of the n weight elements comprises a fixed weight.

Clause 13: The method of any of clauses 9-12, wherein n is an even multiple of four.

Clause 14: The method of any of clauses 9-13, wherein refining the one or more of the set of n weight elements comprises using single instruction, multiple data (SIMD) operations to refine multiple weight elements in parallel.

Clause 15: The method of any of clauses 9-14, wherein refining the one or more of the set of n weight elements comprises: retrieving a first set of weight elements using one or more pointers; incrementing the one or more pointers using one or more fixed offsets; and retrieving a second set of weight elements using the one or more pointers.

Clause 16: A system, comprising: a memory comprising computer-executable instructions; and one or more processors configured to execute the computer-executable instructions and cause the processing system to perform a method in accordance with any of Clauses 1-15.

Clause 17: A non-transitory computer-readable medium comprising computer-executable instructions that, when executed by one or more processors of a processing system, cause the processing system to perform a method in accordance with any of Clauses 1-15.

Clause 18: A computer program product embodied on a computer-readable storage medium comprising code for performing a method in accordance with any of Clauses 1-15.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for a convolutional neural network, comprising:
receiving an input data patch; and
processing the input data patch with a shaped kernel to generate convolution output.

2. The method of claim 1, wherein:
the shaped kernel is associated with a layer of a convolutional neural network model, and
the input data patch comprises input data element values generated, at least in part, by a square convolution kernel of a preceding layer of the convolutional neural network model.

3. The method of claim 1, wherein the shaped kernel comprises a cruciform kernel.

4. The method of claim 1, wherein the shaped kernel comprises a partially-fixed cruciform kernel, wherein a center weight element of the shaped kernel comprises a fixed weight.

5. The method of claim 1, wherein:
the input data patch comprises a set of m input data elements,
the shaped kernel comprises a set of n weight elements,
n<m, and
processing the input data patch with the shaped kernel comprises processing n input data elements of the input data patch with n corresponding elements of the shaped kernel to generate the convolution output.

6. The method of claim 5, wherein processing n elements of the set of m input data elements of the input data patch with n corresponding elements of the shaped kernel comprises:
performing an elementwise multiplication between n−1 input data elements and n−1 weight elements; and
processing a center weight element with a skip connection.

7. The method of claim 5, wherein n is an even multiple of four.

8. The method of claim 5, wherein processing the n input data elements of the input data patch with the n corresponding elements of the shaped kernel comprises using single instruction, multiple data (SIMD) operations to apply multiple weight elements in parallel.

9. The method of claim 1, further comprising:
retrieving a first set of weight elements using one or more pointers;
incrementing the one or more pointers using one or more fixed offsets; and
retrieving a second set of weight elements using the one or more pointers.

10. A method, comprising:
receiving an input data patch associated with a target label;
generating an output based in part on processing the input data patch using a shaped kernel;
computing a loss based on the generated output and the target label; and
refining one or more weight elements of the shaped kernel based on the loss.

11. The method of claim 10, wherein:
the shaped kernel is associated with an internal layer of a convolutional neural network model, and
the input data patch comprises input data element values generated, at least in part, by a square convolution kernel of a preceding layer of the convolutional neural network model.

12. The method of claim 10, wherein the shaped kernel comprises a cruciform kernel.

13. The method of claim 10, wherein the shaped kernel comprises a partially-fixed cruciform kernel, wherein a center weight element of the shaped kernel comprises a fixed weight.

14. The method of claim 10, wherein a number of weight elements in the shaped kernel is an even multiple of four.

15. The method of claim 10, wherein refining the one or more weight elements comprises using single instruction, multiple data (SIMD) operations to refine multiple weight elements in parallel.

16. The method of claim 10, wherein refining the one or more weight elements comprises:
retrieving a first set of weight elements using one or more pointers;
incrementing the one or more pointers using one or more fixed offsets; and
retrieving a second set of weight elements using the one or more pointers.

17. A processing system, comprising:
a memory comprising computer-executable instructions;
one or more processors configured to execute the computer-executable instructions and cause the processing system to perform an operation comprising:
receiving an input data patch; and
processing the input data patch with a shaped kernel to generate convolution output.

18. The processing system of claim 17, wherein the shaped kernel comprises a cruciform kernel.

19. The processing system of claim 17, wherein the shaped kernel comprises a partially-fixed cruciform kernel, wherein a center weight element of the shaped kernel comprises a fixed weight.

20. The processing system of claim 17, wherein:
the input data patch comprises a set of m input data elements,
the shaped kernel comprises a set of n weight elements,
n<m, and
processing the input data patch with the shaped kernel comprises processing n input data elements of the input data patch with n corresponding elements of the shaped kernel to generate the convolution output.

21. The processing system of claim 20, wherein n is an even multiple of four.

22. The processing system of claim 20, wherein processing the n elements of the set of m input data elements of the input data patch with the n corresponding elements of the shaped kernel comprises using single instruction, multiple data (SIMD) operations to apply multiple weight elements in parallel.

23. The processing system of claim 17, the operation further comprising:
retrieving a first set of weight elements using one or more pointers;
incrementing the one or more pointers using one or more fixed offsets; and
retrieving a second set of weight elements using the one or more pointers.

24. A processing system, comprising:
a memory comprising computer-executable instructions;
one or more processors configured to execute the computer-executable instructions and cause the processing system to perform an operation comprising:
receiving an input data patch associated with a target label;
generating an output based in part on processing the input data patch using a shaped kernel;
computing a loss based on the generated output and the target label; and
refining one or more weight elements of the shaped kernel based on the loss.

25. The processing system of claim 24, wherein:
the shaped kernel is associated with an internal layer of a convolutional neural network model, and
the input data patch comprises input data element values generated, at least in part, by a square convolution kernel of a preceding layer of the convolutional neural network model.

26. The processing system of claim 24, wherein the shaped kernel comprises a cruciform kernel.

27. The processing system of claim 24, wherein the shaped kernel comprises a partially-fixed cruciform kernel, wherein a center weight element of the shaped kernel comprises a fixed weight.

28. The processing system of claim 24, wherein a number of weight elements in the shaped kernel is an even multiple of four.

29. The processing system of claim 24, wherein refining the one or more weight elements comprises using single instruction, multiple data (SIMD) operations to refine multiple weight elements in parallel.

30. The processing system of claim 24, wherein refining the one or more of the weight elements comprises:
retrieving a first set of weight elements using one or more pointers;
incrementing the one or more pointers using one or more fixed offsets; and
retrieving a second set of weight elements using the one or more pointers.
